(19) United States
(12) Patent Application Publication
(10) Pub. No.: US 2011/0290788 A1
(43) Pub. Date: Dec. 1, 2011

(54) METHOD AND APPARATUS FOR PROCESSING FRAGMENTED MATERIAL BY PYROLYSIS

(75) Inventor: Andre Klemarewski, North Vancouver (CA)

(73) Assignee: Raute Oyj

(21) Appl. No.: 13/118,707

(22) Filed: May 31, 2011

(30) Foreign Application Priority Data
Jun. 1, 2010 (FI) 20105618

(51) Int. Cl. H05B 6/80

(52) U.S. Cl. 219/680; 219/678

(57) ABSTRACT

A method and an apparatus are provided for processing fragmented material by pyrolysis, wherein the material to be processed is fed into a processing cavity and heated therein. In the method, the fragmented material is continuously fed through the processing cavity and heated at least at the beginning of the process with microwave energy. The apparatus comprises means for feeding the fragmented material to be processed continuously through said cavity; microwave applicator means for initiating heating of the material at the beginning of the process; and means for collecting the pyrolysis end product.

### CROSS-REFERENCE TO RELATED APPLICATION

This application claims priority from and the benefit under 35 U.S.C. §119 of Finnish Patent Application No. 20105618, filed Jun. 1, 2010 in the Finnish Patent Office, which is hereby incorporated herein by reference in its entirety.

### BACKGROUND OF THE DISCLOSURE

1. Field of the Disclosure

The invention relates to a pyrolysis method for processing fragmented material by feeding it in a processing cavity and heating therein and to an apparatus for processing fragmented material by pyrolysis.

2. Description of Related Art

Pyrolysis process of heating wood or other ligno-cellulosic materials at temperature 350° C.-600° C. in low oxygen atmosphere has been used for hundreds of years to produce charcoal. There are many production methods. Some are very primitive batch processes with very low carbon recovery and high air pollution. There are also some very modern methods, where pyrolysis is carried out in industrial type fully enclosed vessel with all gases recovered and high carbon recovery. Wood species on average have 50% carbon content and this is the maximum theoretical charcoal or bio-carbon recovery. Charcoal recovery with primitive batch methods is 15-25%. New industrial methods claim charcoal recovery from wood up to 40%. Another process used for improving biomass heat value is torrefaction. Torrefaction is basically incomplete pyrolysis and can be carried out at lower temperatures between 250° C. and 350° C. Torrefaction is being used for treating wood waste prior to pelletizing. Torrefied pellets have higher heat content of 21 MJ/kg in comparison to 16 MJ/kg for standard wood pellets. They also do not absorb water and are resistant to biological attack. Torrefied pellets are very attractive and environmentally friendly fuel.

U.S. Pat. No. 4,118,282 is related to a batch process carried out in an enclosed chamber. It is for cracking/breakdown of polymeric hydrocarbons (plastics). The process is initiated by laser, which burns plastic and creates carbon residue, and microwaves are attracted to carbon in a continuous heating process. U.S. Pat. No. 6,184,427 is related to a process for cracking hydrocarbons (plastics). Since plastics have low dielectric loss factor (do not heat well in microwave), sensitizers or materials with higher dielectric loss are mixed therein. The process is continuous but plastic is extruded in spaghetti like ribbons and moves down by gravity through a reactor.

### BRIEF SUMMARY OF THE DISCLOSURE

An object of the present invention is to provide an improved pyrolysis method and apparatus. The object of the invention is achieved by a method wherein at least majority of the fragmented material to be processed is biomass; that the fragmented material is continuously fed through the processing cavity and heated at least at the beginning of the process with microwave energy, and that the fragmented material is compacted before applying microwave energy. The apparatus of the present invention comprises means for feeding the fragmented material to be processed continuously through said cavity and for compacting the fragmented material to be processed; microwave applicator means for initiating heating of the material at the beginning of the process; and means for collecting the pyrolysis end product.

According to a preferred embodiment of the inventive method, the middle of the continuously transported biomass is heated with microwave energy and the outside layers of biomass material are heated by hot air and combustion gases.

The pyrolysis method of the present invention has several advantages over the existing pyrolysis processes:

It can be applied to variety of input materials like wood, urban wood waste, coconut shells, grass, reed and many other plant materials. It can also be applied to waste plastic and rubber.

It can accept small particles like saw dust and a mixture of small and larger particles like saw dust and wood chips.

Fast processing time due to efficient microwave heating. The whole pyrolysis process is expected to last 5 to 15 minutes. Competitive flash pyrolysis processes are even faster but limited to very small particle size material.

Fast start up and shut down. There is very short (about 5 minutes), microwave generator warm up time. Other processes require much longer warm up time.

Pyrolysis is carried out in an enclosed processing cavity in naturally low oxygen atmosphere.

Biomass particles are compacted to density between 0.30 g/cm³ and 1.2 g/cm³. Air pockets are mostly eliminated. Microwave energy application and heat conduction from heated zone to non-heated zone is greatly improved.

Easy process control with fully adjustable microwave power input and extrusion speed.

Process becomes exothermic after core temperature has reached about 270° C. and it can continue without any microwave power input.

Steam, liquids and gases created during pyrolysis process can be extracted at specific points along the processing cavity.

Extrusion process is self cleaning due to high compaction of biomass and friction against the cavity and microwave applicator walls.

Process is carried out in enclosed environment with complete control of gas, liquid and solid by products. It produces virtually no air pollution.

The same equipment can be use for torrefaction of biomass or charcoal production.

Bio-carbon recovery will be close to the maximum possible due to relatively low processing temperature and completely enclosed system.

### BRIEF DESCRIPTION OF THE SEVERAL VIEWS OF THE DRAWING(S)

In the following, the invention will be described in greater detail by way of exemplary embodiments with reference to the attached drawings, in which

FIG. 1 shows schematically an example structure of a pyrolysis apparatus according to an embodiment of the present invention; and

FIG. 2 shows a cross-sectional view of the apparatus of FIG. 1 immediately after the last microwave applicator.

### DETAILED DESCRIPTION OF THE DISCLOSURE

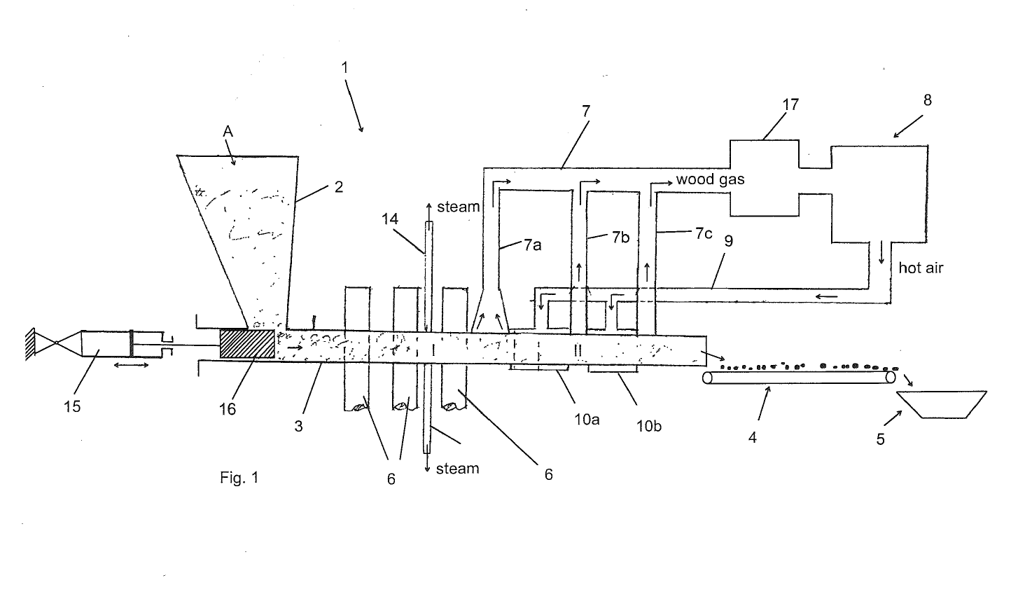

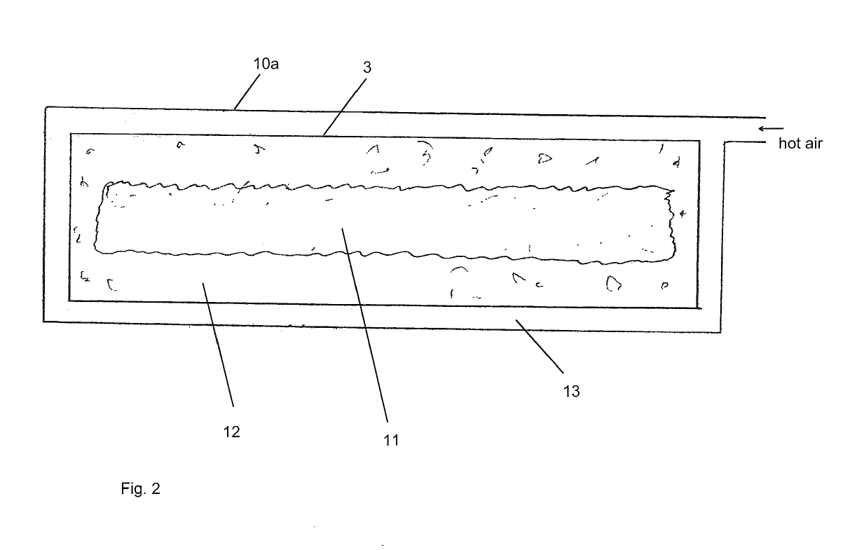

The principle of the pyrolysis method of the present invention is shown in FIGS. 1 and 2. Wood residue, plant fragments, nut shells, straw or any fragmented biomass of moisture content of up to 30% can be used in this process. Biomass has to be reduced in size small enough to be extruded with a screw or piston type extrusion process. Particle size should preferably be between 0.50 mm and 60 mm.

Biomass particles are first fed into a hopper 2. At the bottom of the hopper is an extrusion mechanism, which pushes the material forward into an elongated processing cavity 3. In the present embodiment the extrusion mechanism comprises a cylinder 15 and a piston 16. The processing cavity 3 is preferably rectangular in shape and has dimensions between 20 mm and 300 mm in height and between 200 mm and 1300 mm in width. The processing cavity can also be circular or elliptical in cross-section. As biomass is pushed into the processing cavity 3 it is compressed and any large air pockets are eliminated. Along the processing cavity there is at least one and preferably several microwave applicators 6, which are connected with wave guides to microwave generators. There are two industrial microwave frequencies assigned for heating—2450 Mhz and 915 Mhz. Any of these frequencies can be used but microwave applicator dimensions have to be designed for one of these frequencies. It is preferred that the microwave applicator used is of type with horizontal polarization. In this kind of applicator, maximum microwave energy and heating can be directed to the middle of the applicator cross section or the middle of the processing cavity or to the outside of the processing cavity. An example of an apparatus for microwave heating is disclosed in US 2010/0060391 A1, assigned to the applicant of the present application.

In the present case it is preferred to start heating the middle part of the processing cavity. As the biomass product is progressing through the processing cavity 3 it is subjected to multiple stages of heating. After the core temperature reaches about 250° C., shorter chain biomass carbohydrates start decomposing and turning into gas. Steam gained from the early stage of microwave heating is lead via channels 14 away from the cavity 3. It is conceivable to use steam for preheating of the material prior to feeding the material into the cavity. Processing cavity walls are provided with perforations between microwave applicators 6. A negative pressure is applied and any gas created from biomass decomposition is transported to a condenser 17 where water is separated from gas. Gases from the pyrolysis in the core warm up in an effective way the outer layer when flowing outwards.

Dry gas is directed via channels 7a, 7b, 7c, 7 to a burner 8, where it is ignited. Hot gas and hot air generated during the combustion process are directed via channel 9 to chambers 10a, 10b surrounding the processing cavity 3 forming a heating cavity 13 therebetween. The intent is to heat processing cavity walls in between and downstream from microwave applicators 6. Temperature of the hot air and hot gas in channel 9 is preferably between about 700° C. and 900° C. and in chambers 10a, 10b between about 500° C. and 700° C. Hot metal walls in turn will conduct heat to the outside layer 12 of processed biomass. At the end of the process the whole cross section of processed material is heated to a temperature of between 300° C. and 400° C. At this temperature and in the absence of an external oxygen supply, the biomass material is completely pyrolyzed. Short chain carbon hemicelluloses are gasified and long chain carbon polymer cellulose is converted to carbon. Charcoal is cooled, fed to a belt conveyor 4 and forwarded to a collecting vessel 5.

The speed and degree of pyrolysis can be well controlled by the amount of microwave power applied and speed of extrusion through the processing cavity.

At 270° C., a wood oxidation reaction is exothermic and does not require any external heat. So it is also possible to heat core material to about 300° C. with microwave energy and the pyrolysis process would continue on its own. The core material to be heated to about 300° C. includes preferably between 30% and 70% of cross section, but it can be smaller, resulting, however, in a longer pyrolysis process time. Heating of external layers 12 with hot gas will accelerate that process but is not necessary. The process can also be accomplished with 100% of heating carried out by microwave energy. In that case consecutive microwave applicators are designed to heat the whole cross section of the processing cavity to a uniform temperature.

It may be beneficial to have the pyrolysis process incomplete and to carry it out at temperature between 200° C. and 320° C. It is called torrefaction. Torrefied biomass has higher heat value in comparison to wood due to higher carbon content. Torrefied wood absorbs very little moisture and it is biologically resistant. It is therefore a preferred material for fuel pellet preparation.

The main advantages of the inventions are:

Flexibility in materials that can be processed: from rice husk, crushed nut shell to mixed urban wood waste. Ground up rubber and plastic is also contemplated to be processed.

Flexibility of the process. The same equipment could be used for complete pyrolysis, where charcoal is the final product, or partial pyrolysis producing torrefied wood.

The above is possible because of very good control of the pyrolysis temperature. This is achieved by adjusting material speed (piston rpm or screw feed rpm) and microwave power.

Highest possible bio-carbon recovery due to very controlled process.

The process will be very efficient and truly a combination of microwave and conventional syngas heating. Microwave heats the middle part of the material to be processed and syngas heats the outside thereof. Previously known processes are either 100% syngas heating (not efficient on big chunks of wood) or 100% microwave heating.

The fragmented material is compacted at all times providing for very good heat transfer from pyrolyzed portion to non-pyrolyzed portion.

The invention provides a modern, compact, flexible and economical system for biomass value enhancement. It is suitable for small to medium size processing lines between 5000 tons/year and 25000 tons/year of biomass. Larger volumes can be processed with multiple lines.

That which is claimed:

1. A method for processing fragmented material by pyrolysis, wherein the material is fed into a processing cavity and heated therein, and wherein at least a majority of the fragmented material to be processed is biomass; the fragmented material is continuously fed through the processing cavity and heated at least at the beginning of the process with microwave energy; and the fragmented material is compacted before applying microwave energy.

2. A method according to claim 1, wherein the fragmented material is compacted to a density of between 0.20 g/cm³ and 1.20 g/cm³ before applying microwave energy.

3. A method according to claim 1, wherein the heating of the fragmented material is initiated by microwave energy and then maintained by biomass exothermic reaction.

4. A method according to claim 1, wherein the fragmented material to be processed in the processing cavity is biomass, and biomass is heated first with microwave energy in the middle of its cross-section and outside layers thereof are heated with an external heat source.

5. A method according to claim 4, wherein the outside layers of biomass are heated with hot gas produced after combustion of pyrolysis gas produced in the initial microwave heated core biomass process.

6. A method according to claim 1, wherein a continuous pyrolysis process is carried out with 100% microwave energy and resulting pyrolysis oil and gases are collected and used for other processes.

7. A method according to claim 1, wherein the microwave energy is generated by at least one microwave applicator with horizontal field polarization and the microwave energy is concentrated in the middle of extruded material.

8. A method according to claim 1, wherein the fragmented material is forced through an elongated processing cavity by one of an extrusion screw and a pushing piston.

9. A method according to claim 1, wherein the pyrolysis process is initiated with microwave energy having a frequency between 400 Mhz and 2450 Mhz.

10. An apparatus for processing fragmented material, of which at least a majority is biomass, by pyrolysis in a processing cavity, wherein the apparatus comprises means for feeding the fragmented material to be processed continuously through said cavity and for compacting the fragmented material to be processed; microwave applicator means for initiating heating of the material at the beginning of the process; and means for collecting the pyrolysis end product.

11. An apparatus according to claim 10, further comprising means for collecting pyrolysis gas produced during the initial microwave heating of the fragmented material.

12. An apparatus according to claim 11, further comprising means for burning the pyrolysis gas and means for feeding hot air from the burner means to a chamber surrounding the processing cavity for heating outside layers of the fragmented material.

13. An apparatus according to claim 10, wherein the processing cavity is elongated and rectangular in shape having dimensions of between 20 mm and 300 mm in height and between 200 mm and 1300 mm in width.

14. An apparatus according to claim 10, wherein the processing cavity is elongated and has a circular or oval cross-section.
